(19) United States
(12) Patent Application Publication
(10) Pub. No.: US 2012/0001431 A1
(43) Pub. Date: Jan. 5, 2012

(54) METHOD AND APPARATUS FOR ENERGY GENERATION

(76) Inventor: George Smith, Aberdeenshire (GB)

(21) Appl. No.: 13/145,102

(22) PCT Filed: Jan. 22, 2010
(86) PCT No.: PCT/GB2010/050097

§ 371 Date: Sep. 21, 2011

(30) Foreign Application Priority Data
Jan. 22, 2009 (GB) 0900982.0

(51) Int. Cl. F03B 13/18

(52) U.S. Cl. 290/53

(57) ABSTRACT

A wave energy generator is disclosed with one or more wave follower connected to a fixed structure such as the leg or jacket of a wind turbine, and an energy converter to convert kinetic energy from the movement of the wave followers into electric energy, wherein the wave follower is connected to the fixed structure through an adjustment mechanism configured adjust the position of the wave follower to move it rotationally and/or vertically relative to the fixed structure, so that the adjustment mechanism allows adjustment of the range of movement of the wave follower.

The present invention relates to a method and apparatus for generation of energy from wave motion. In certain embodiments, the invention allows conversion of kinetic energy from wave motion into a relatively constant supply of electrical energy.

Conversion of kinetic energy from waves into electrical energy is well known. Our earlier publication WO2006/079812 (incorporated herein by reference) discloses a wave energy generator for converting kinetic energy.

According to a first aspect of the present invention there is provided apparatus for generating electric energy from wave motion, comprising:
at least one wave follower configured to be moved by wave motion; and
an energy converter configured to convert kinetic energy from the movement of the wave followers into electric energy;
wherein the at least one wave follower is configured to connect to a fixed structure, and wherein the apparatus has an adjustment mechanism configured to move the wave follower rotationally and/or vertically relative to the fixed structure.

According to a second aspect of the present invention there is provided a method for energy generation from wave motion comprising:
providing at least one wave follower configured to move in response to wave motion;
converting kinetic energy of the wave follower into electrical energy;
wherein the at least one wave follower is configured to connect to a fixed structure; and is configured to move rotationally and/or vertically relative to the fixed structure.

Typically the movement of the wave follower is pivotal movement with respect to the fixed structure and the adjustment mechanism allows adjustment of the location of the pivot point of the wave follower with respect to the fixed structure, thereby allowing adjustment of the range of movement of the wave follower.

Optionally the apparatus can comprise an energy transfer mechanism wherein the energy transfer mechanism converts the kinetic energy from movement of the or each wave follower to potential energy, e.g. by pressurisation of a fluid or by some other means, and the energy converter converts the potential energy into electrical energy.

Optionally the apparatus has a chamber arranged to store the pressurised fluid.

Typically the adjustment mechanism is configured to move rotationally around an axis of the fixed structure, and typically in a generally horizontal plane, generally parallel with the waterline.

Typically the adjustment mechanism is configured to move vertically on the same axis of the fixed structure, generally orthogonally to the plane of rotational movement.

Typically the adjustment mechanism is connected to the fixed structure, optionally around the fixed structure, and is movable rotationally (e.g. around the axis of the fixed structure) and/or vertically (e.g. along the axis of the fixed structure) with respect to the fixed structure. Typically the adjustment mechanism is connected around the fixed structure and the two are co-axial.

The wave follower can optionally comprise a float and an arm, and is typically connected to the adjustment mechanism, and optionally can be pivotally connected thereto at a pivot point, e.g. allowing pivoting between the arm and the adjustment mechanism. The pivot point is typically movable with the adjustment mechanism rotationally and/or vertically with respect to the fixed structure.

The adjustment mechanism can comprise a vertical traveller and a rotational traveller, which can be separate or combined, and which are typically in the form of annular rings, interconnected by struts or beams; the rings can be solid or split to allow for removal and replacement of the rings from the fixed structure.

Incorporating a pivot or other movable joint on the float of the wave follower has the advantage that it can optionally pivot to move with the wave. In some embodiments, the float is adapted to pivot around one horizontal axis (e.g. the axis of the float, extending parallel to the plane of rotation and the waterline), so that the float can pitch up and down in the vertical plane. For example, in the case where the horizontal plane of the waterline lies on the X and Z axes, with the vertical axis of movement of the vertical traveler constituting the Y axis and the long axis of the arm constituting the X axis, if the float is pivotally connected to the arm around a horizontal pivot axis extending along the Z axis (parallel to the water line and to each of the X and Y axes) allowing the float to pivot or otherwise move up and down in the vertical (XY) plane, then the float can lie across the wave face as it hits the float, hence absorbing horizontal and vertical energy from the wave. This represents an advantage over the float being rigidly attached to the arm and held in the same orientation with respect to the wave, and allowing only the absorption of kinetic energy resulting from vertical movement of the wave follower. Also, the pivoted float is more adaptable to absorb energy from different heights of wave than would be the case with a rigidly attached float. The float typically contains a buoyant material and typically supports the arm. The float can typically be connected to the arm by a pivot. The pivot can optionally be at the top of the float or at the bottom of the float. In some embodiments any optional pivotal attachment can be located between the top and the bottom of the float.

In some embodiments, the arm can be generally perpendicular to the vertical axis of movement of the adjustment mechanism, so that the arm extends generally horizontally, and more of the moving parts of the apparatus can be located above the waterline. In some embodiments, portions of the arm (and the connection with the float) can be submerged, and the arm can be non-parallel to the waterline.

Additionally or alternatively, the float can be configured to pivot around a different horizontal axis, such as the X-axis, so as to be pivotable around an axis that is parallel to the arm, typically by incorporating a swivel joint on the float, typically located between the float and the arm connecting the float to the adjustment mechanism. This optionally allows the float to roll laterally with respect to the arm when waves hit it from the side without necessarily transmitting the resultant torque to the arms. This can improve the fatigue life of the arms and the float, and also keeps the float more in contact with the surface of the wave during its passage, which can lead to better power absorption from movement of the arms in the vertical plane.

In some embodiments of the invention, the pitching movement of the float can be converted into electrical energy, optionally being first converted into potential energy and stored in an accumulator or other energy storage device. For this purpose, the apparatus can optionally have an energy conversion device adapted to connect across the pivot joint on the float, indirectly connecting the float and the energy convertor for example in the form of a fluid compressor such as a hydraulic cylinder connected between a portion of the arm or the adjustment mechanism, and the float, so that pitching movement of the float in the manner described above is adapted to be converted into potential or electrical energy by the compression of the fluid.

In some embodiments the arrangement of wave followers can be asymmetric, for example, with one wave follower spaced further from the adjustment mechanism than others. For example, in the embodiment shown in the figures, two wave followers can be adopted, each attached to the adjustment mechanism by means of arms, one of which can be longer than the other. This allows the apparatus to passively weathervane, which encourages the forward wave follower to face into the waves.

The apparatus can comprise a wave direction sensor. Wave direction could optionally be estimated from wind direction determined by a wind direction sensor, which may optionally be mounted on the adjustment mechanism. Alternatively or additionally, this might comprise a number of conventional water level sensors arranged around the periphery of the adjustment mechanism, around the vicinity of the water line, and optionally linked to a processor configured to compare the instantaneous wave heights on each of the sensors. An indication that the sensors on one side of the apparatus were triggering increased water depth before the sensors on the other side could be used to indicate that waves were coming from the direction of the first side.

Alternatively or additionally, optical sensors could be mounted on the adjustment mechanism to monitor the relationship of the sponson to the arm at a pivot point between the two, and to make appropriate adjustments to the adjustment mechanism to ensure that the power absorption is optimal. For example, if the apparatus is at optimal orientation to the wave direction, the sponson should be generally horizontal, but if one sponson is pitching substantially off the horizontal, then the adjustment mechanism can optionally be activated to move the wave followers in the appropriate direction.

The wave follower (and optionally the adjustment mechanism or a portion thereof) is typically rotated around the fixed structure in the horizontal plane, and allows the wave follower to be positioned in alignment with the wave direction, so that the wave follower is absorbing the maximum possible energy from the waves. The wave follower can be moved rotationally (i.e. in the horizontal plane, across the water line) by manual or automatic rotation mechanisms. The rotation mechanisms can be linked to and can move in response to the wave directional sensors that sense the prevailing direction of the waves striking the wave follower, and the rotation mechanisms can adjust the rotational position of the wave follower in accordance with the direction sensed by the directional sensors.

The apparatus and method translates kinetic energy from wave motion to the wave follower by motion of the waves. Movement of the wave follower can optionally be used to pressurise a fluid thereby converting the kinetic energy into potential energy. The potential energy can optionally be stored in the chamber before being released on demand to create electric energy using the energy converter. Thus the apparatus and method of the present invention enables wave energy to be harnessed and converted into electricity.

The adjustment mechanism can be arranged so that the wave follower pivots around a median position which is generally perpendicular to the seabed. Typically a substantial proportion of the adjustment mechanism is arranged to protrude from the surface of the water.

The fixed structure can typically comprise a vertical column. The column can comprise the leg or base of a fixed structure, such as an oil rig, tidal device, or a wind turbine. The column can comprise a base, such as a monopile, or can be mounted on such as base, or may itself have a similar or different foundation structure. Suitable foundations (monopiles, jackets, towers etc) for wind turbines and oil platforms such as jackets are known in the art and can be used as foundations for the column. It is advantageous to connect the apparatus to fixed structures like wind turbines which have mechanisms for export of electrical power already in place. Typically the power generated by the apparatus can be exported using the power export mechanisms already in place on a structure.

The apparatus can have a height sensor that senses and optionally relays the height of the apparatus (or certain components thereof) above the water in which the apparatus is being used. The height sensor can optionally be a flood chamber or tube, having a restricted orifice for admission of water. The chamber typically fills up passively with water as a result of wave action. The height of the water column in the flood chamber (which can be measured by a float or an ultrasonic sensor) gives an indication of the height of the apparatus above the mean water line. The height sensor can then relay the indication to a controller which initiates vertical movement through the adjustment mechanism to adjust the vertical height of the apparatus above the water line in order to compensate for changes in the water line height e.g. arising from tidal movements. This allows the arms to be operated at a consistent height above the water line despite changes in water line height resulting from tidal fluctuations, and therefore allows the arms to operate in their most efficient range. The height sensor can have a reporting interval that is set in advance, e.g. 15 minutes, longer in calmer conditions, and shorter in rougher conditions.

The apparatus can be retro-fitted to existing fixed structures, like existing oil rigs and wind turbine columns, or can be incorporated into such structures during manufacture and/or before deployment, allowing fitting of the components onshore. In embodiments that are incorporated into newly built or non-deployed structures, certain attachment mechanisms could in theory be omitted, and in such cases the adjustment mechanism can optionally be built into the structure.

In some embodiments, each wave follower can energise a central energy transfer mechanism, but typically, one or more separate energy transfer mechanisms can be provided on each of the wave followers. Typically the apparatus is arranged such that any substantially vertical displacement or pitch of the or each wave follower causes actuation of the or each energy transfer mechanism.

A plurality of wave followers can be provided. In some embodiments, there are two wave followers, which can typically be arranged at 180 degrees in relation to one another. In such embodiments, the rotational alignment of one of the wave followers with the prevailing wave direction serves to align both of them, with one forward wave follower, and one aft wave follower, each in alignment with one another, and with the wave direction.

Each wave follower can include a float or a body which is arranged to at least partially float. The float can be pivotally attached to the apparatus, and is typically pivotally attached to an arm of the apparatus.

The energy converter can comprise an electrical generator. The generator can be driven by hydraulic fluid pressurised by the energy transfer mechanism. Alternatively the energy converter can be driven mechanically by the direct movement of the wave followers, optionally via appropriate gears and linkages.

Other designs of energy converter can be used without relying on hydraulics. For example the generator can be driven directly from the wave follower motion via a rack and pinion system operating typically between the arms and a rotational or linear generator.

The or each energy transfer mechanism can be located between the or each wave follower and the adjustment mechanism. The or each wave follower can be coupled to an arm (e.g. at one end of the arm) and the arm can be pivotally coupled (e.g. at the other end of the arm) to the adjustment mechanism.

The energy transfer mechanism can comprise a fluid compressor that can be coupled to the wave follower such that movement of the at least one member causes compression of fluid in the fluid compressor.

The fluid compressor can be coupled between the wave follower and the adjustment mechanism, and can typically be coupled to the adjustment mechanism (e.g. to the adjustment mechanism) at a point vertically spaced from the pivotal coupling of the adjustment mechanism (e.g. the adjustment mechanism) and the arm.

The fluid compressor preferably comprises a rod and a piston moveable within a cylinder containing fluid (gas or liquid). Alternatively the fluid compressor can optionally comprise a rack and pinion mechanism and rotary compressor. Typically more than one piston and cylinder arrangement can be provided for each of the wave followers, and can optionally be activated together or individually (e.g. in sequence) and can typically permit adaptation of the apparatus to different amplitudes of wave energy input, so that the apparatus can operate in different wave conditions, and still maintain a relatively steady output from each of the cylinders.

In some embodiments the pressurised fluid can be stored in an accumulator. The accumulator is typically connected between the fluid compressor and the potential energy converter. In one form, the accumulator can be a hydraulic accumulator. The accumulator can comprise a pneumatic accumulator as shown in our earlier application WO2006/079812 (the disclosure of which is incorporated herein by reference) or can comprise a hydraulic accumulator.

In some embodiments, the accumulator can be an electronic accumulator. Optionally a control system is used on the electrical system where the electricity can be generated in DC and power control electronics then converts this back to AC power. This system could be used in conjunction with or instead of the hydraulic accumulator system.

Optionally, the energy converter comprises a hydraulic motor coupled to one or more electricity generators.

Two or more hydraulic motors and generators can be provided. It is beneficial to employ two or more generators since during light wave conditions one generator may be used and additional generators may be introduced in conditions with greater wave amplitude and frequency. This arrangement enables power generation throughout a range of wave conditions. Additionally, multiple generators increase the reliability and reduce the possibility of complete shutdown; in the event of a single failure there remains at least one other generator to continue energy generation. This is particularly important when the apparatus is used in harsh conditions in remote locations which may be difficult to access by repair personnel.

A control system can allow the generators to be cycled to ensure each generator has substantially even running hours.

The present invention typically enables a pulsed energy input created by motion of the waves to be converted into a more constant stable supply for a generator while maintaining a high level of efficiency. This can allow for successful energy generation from a variety of input wave conditions. The simple design ensures low build costs and gives high reliability.

The various aspects of the present invention can be practiced alone or in combination with one or more of the other aspects, as will be appreciated by those skilled in the relevant arts. The various aspects of the invention can optionally be provided in combination with one or more of the optional features of the other aspects of the invention. Also, optional features described in relation to one embodiment can typically be combined alone or together with other features in different embodiments of the invention.

Various embodiments and aspects of the invention will now be described in detail with reference to the accompanying figures. Still other aspects, features, and advantages of the present invention are readily apparent from the entire description thereof, including the figures, which illustrates a number of exemplary embodiments and aspects and implementations. The invention is also capable of other and different embodiments and aspects, and its several details can be modified in various respects, all without departing from the spirit and scope of the present invention. Accordingly, the drawings and descriptions are to be regarded as illustrative in nature, and not as restrictive. Furthermore, the terminology and phraseology used herein is solely used for descriptive purposes and should not be construed as limiting in scope. Language such as “including,” “comprising,” “having,” “containing,” or “involving,” and variations thereof, is intended to be broad and encompass the subject matter listed thereafter, equivalents, and additional subject matter not recited, and is not intended to exclude other additives, components, integers or steps. Likewise, the term “comprising” is considered synonymous with the terms “including” or “containing” for applicable legal purposes.

Any discussion of documents, acts, materials, devices, articles and the like is included in the specification solely for the purpose of providing a context for the present invention. It is not suggested or represented that any or all of these matters formed part of the prior art base or were common general knowledge in the field relevant to the present invention.

In this disclosure, whenever a composition, an element or a group of elements is preceded with the transitional phrase “comprising”, it is understood that we also contemplate the same composition, element or group of elements with transitional phrases “consisting essentially of, “consisting”, “selected from the group of consisting of”, “including”, or “is” preceding the recitation of the composition, element or group of elements and vice versa.

All numerical values in this disclosure are understood as being modified by “about”. All singular forms of elements, or any other components described herein including (without limitations) components of the apparatus to collect cuttings are understood to include plural forms thereof and vice versa.

In the accompanying drawings:

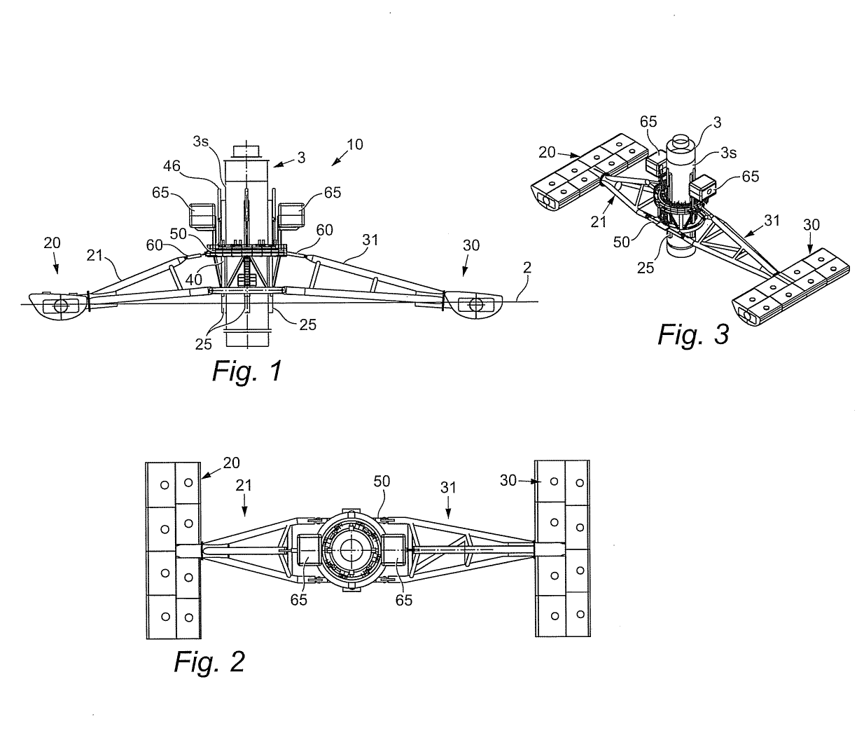

FIG. 1 is a side view of wave energy generation apparatus according to one embodiment, attached to a column of a wind turbine;

FIG. 2 is a plan view of the apparatus of FIG. 1;

FIG. 3 is a perspective view of the apparatus of FIGS. 1 and 2;

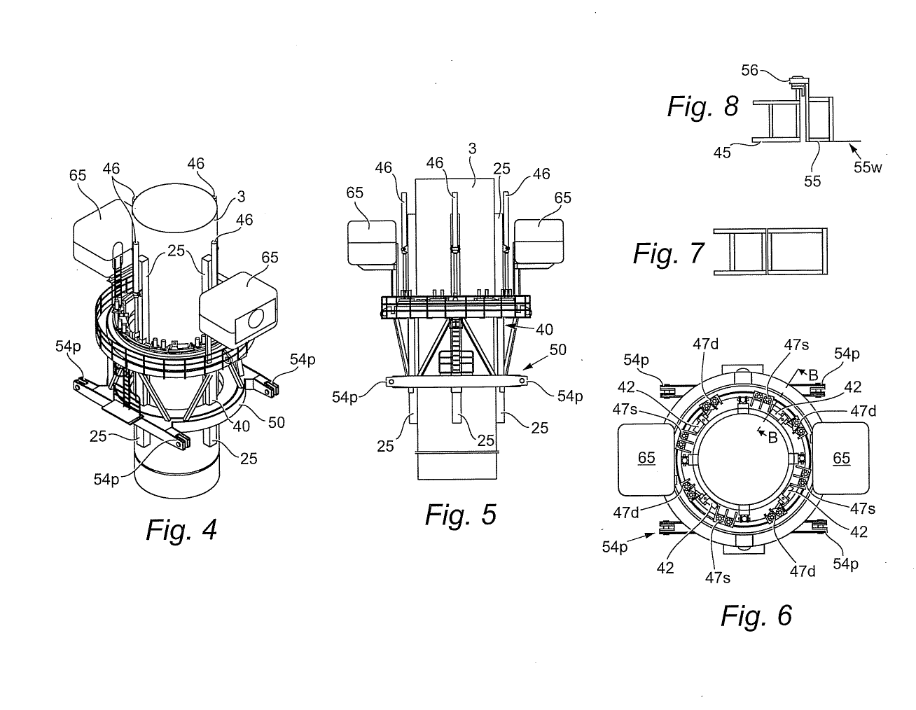

FIG. 4 is close up perspective view of the FIG. 1 apparatus with the arms detached for clarity;

FIG. 5 is a side view corresponding to FIG. 4;

FIG. 6 is a plan view corresponding to FIG. 4;

FIGS. 7 and 8 show details of FIG. 6;

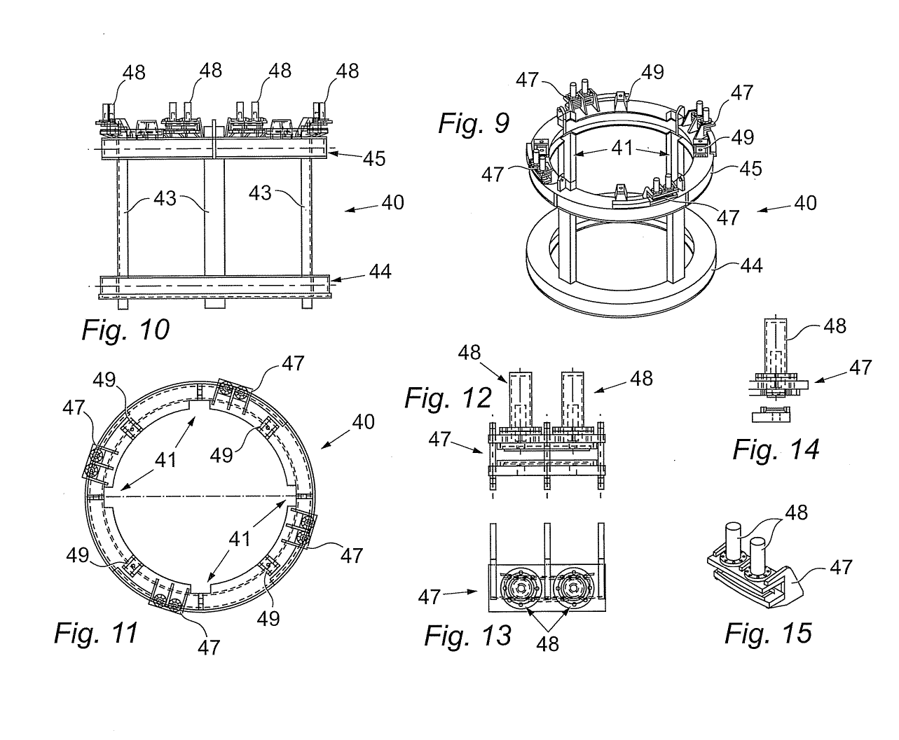

FIG. 9 is a perspective view of a vertical traveller adjustment mechanism of the FIG. 1 apparatus;

FIG. 10 is a side sectional view of FIG. 9;

FIG. 11 is a plan view of FIG. 9;

FIGS. 12-15 show details of the vertical traveller adjustment mechanism of FIG. 9;

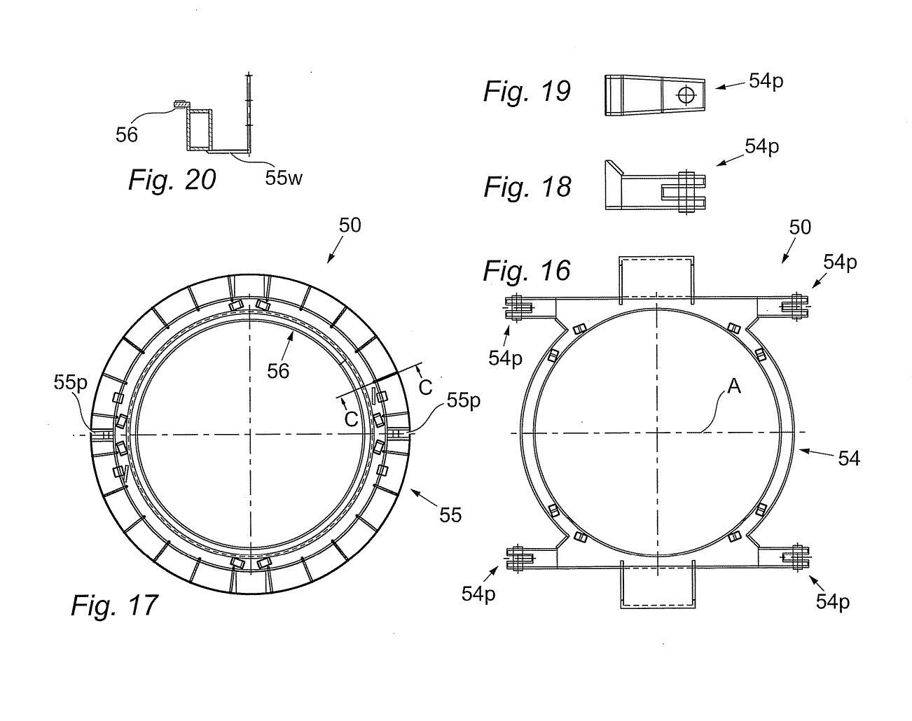

FIG. 16 shows a plan view of a lower ring of a rotational traveller of the FIG. 1 apparatus;

FIG. 17 shows plan view of an upper ring of a rotational traveller of the FIG. 1 apparatus;

FIGS. 18-20 show details of the rotational traveller of FIGS. 16 and 17;

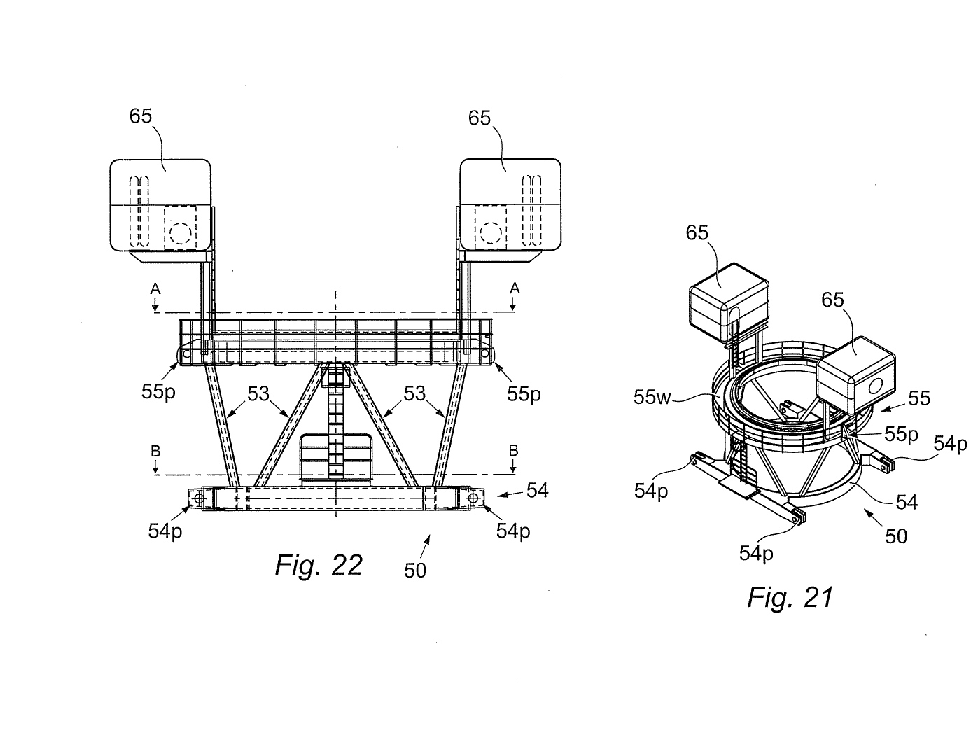

FIG. 21 shows a perspective view of the rotational traveller shown in FIGS. 16 and 17;

FIG. 22 shows a side sectional view of the rotational traveller shown in FIG. 21;

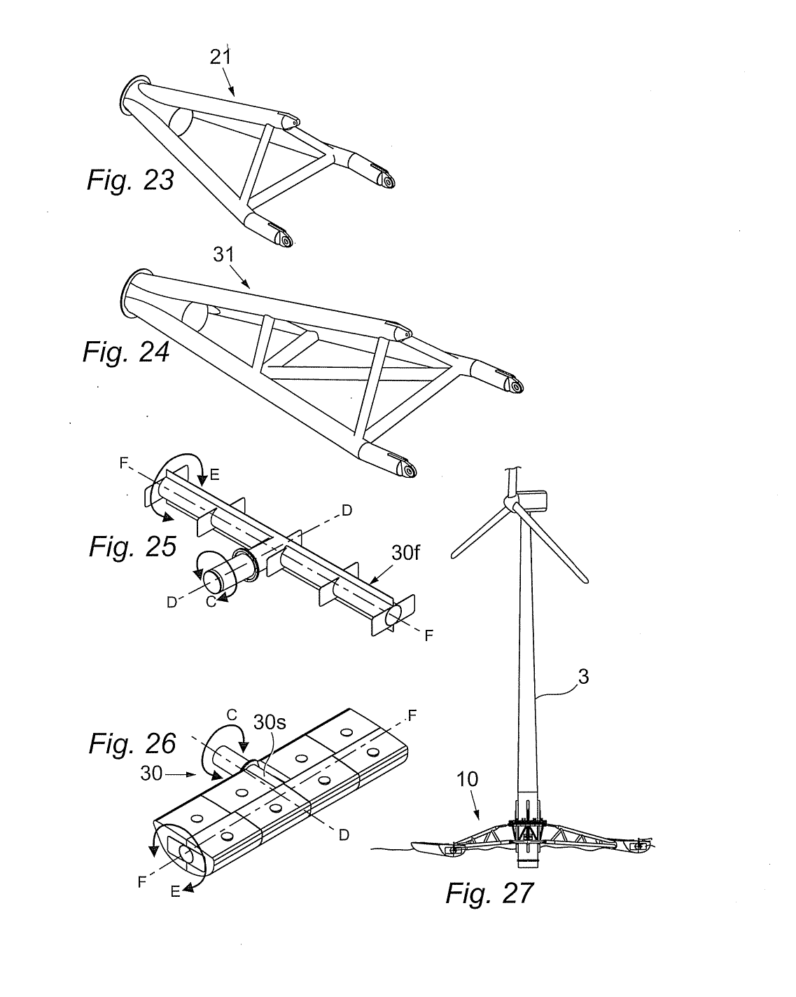

FIGS. 23 and 24 respectively show a forward and aft wave follower arm of the FIG. 1 apparatus;

FIG. 25 shows a sponson adjustment mechanism of the FIG. 1 apparatus;

FIG. 26 shows an assembled forward sponson of the FIG. 1 apparatus;

FIG. 27 shows a perspective view of the FIG. 1 apparatus;

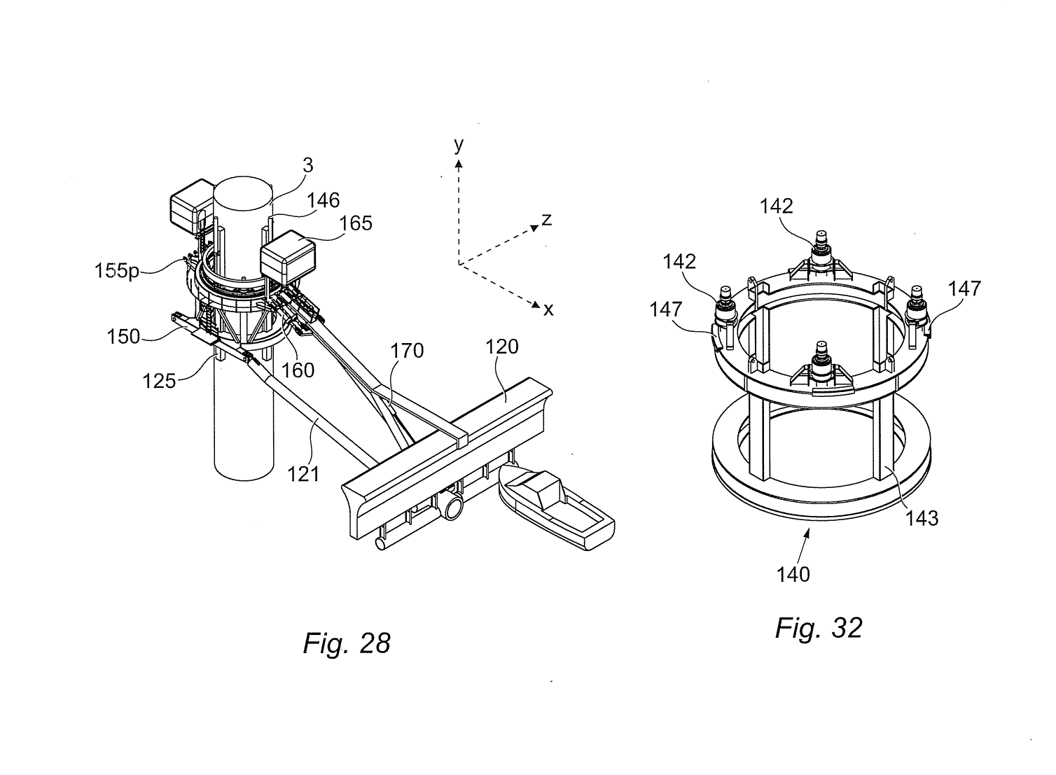

FIG. 28 shows a perspective view of a second embodiment;

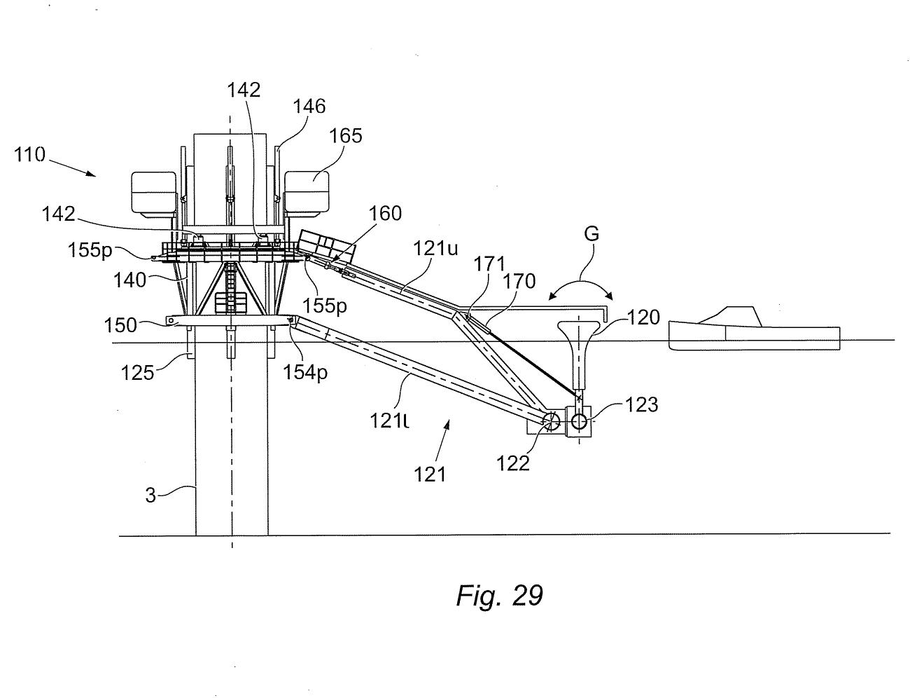

FIG. 29 shows a side view of the second embodiment shown in FIG. 28;

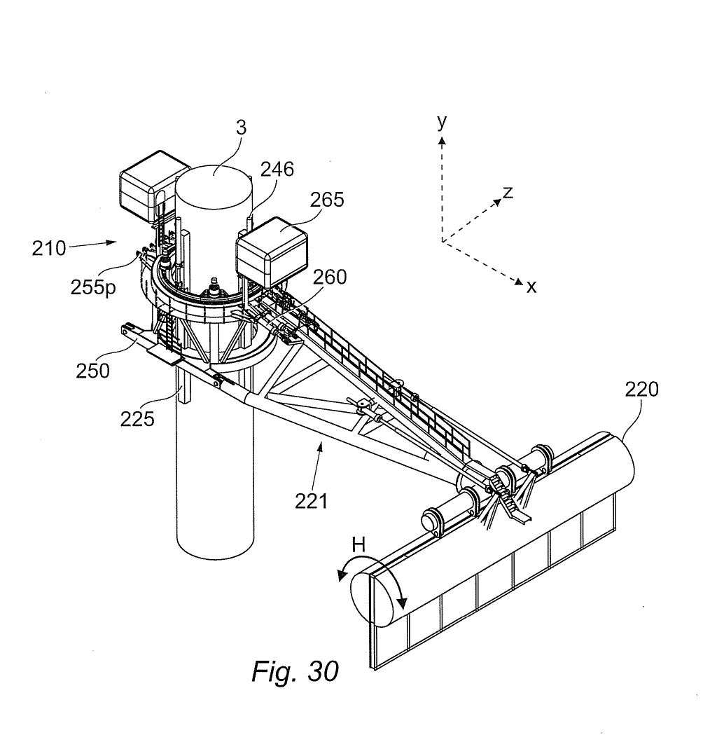

FIG. 30 shows a perspective view of a third embodiment;

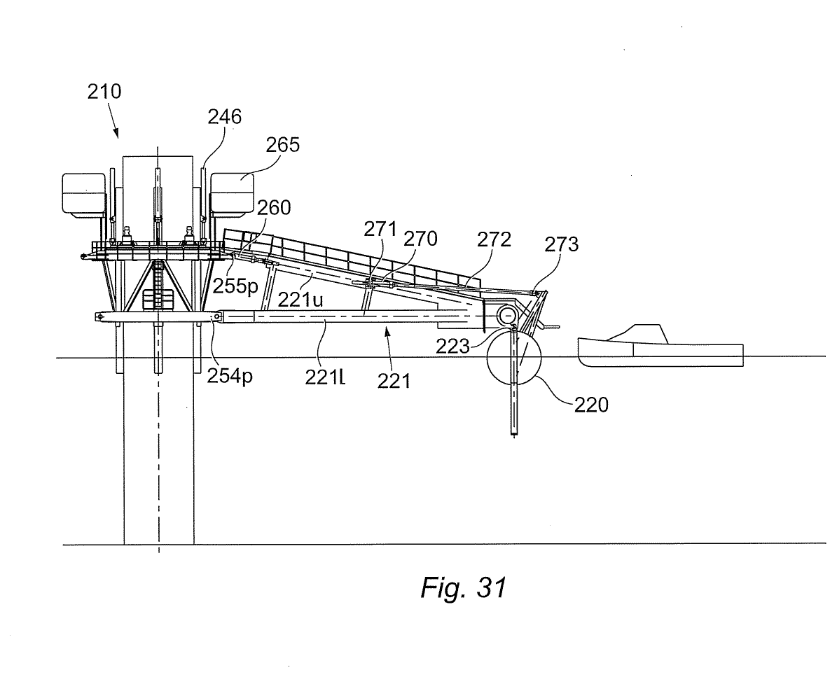

FIG. 31 shows a side view of the third embodiment shown in FIG. 30;

FIG. 32 shows a perspective view of a vertical traveller component of the adjustment mechanism used in the embodiments of FIGS. 28-31;

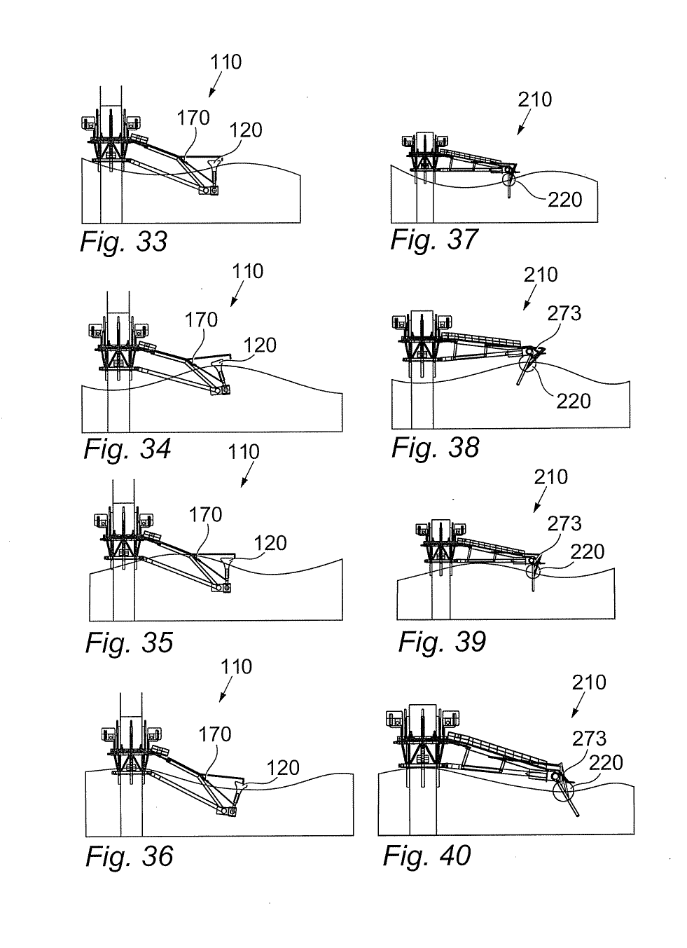

FIGS. 33-36 show a sequence of operation of the second embodiment of FIGS. 28 and 29; and

FIGS. 37-40 show a sequence of operation of the third embodiment of FIGS. 30 and 31.

FIG. 1 shows wave energy generation apparatus indicated generally at 10. The apparatus 10 comprises two wave followers in the form of floats, although the skilled person will appreciate that more than or less than two floats could be used. The floats are in the form of forward and aft sponsons 20, 30 (FIG. 26) each of which comprises a rigid sub frame on which is mounted buoyant blocks manufactured from a material less dense than water and more dense than air to ensure that they float on the surface 2 of the water. The aft sponson 30 is shown in FIG. 26 and its sub frame 30t is shown in FIG. 25. The skilled person will appreciate that different designs of float can be used, and that forward and aft sponsons can be of the same design, or can be different. The sponsons 20, 30 are typically pivotally attached to the outer ends of respective lever arms 21 and 31. The inner ends of the arms 21, 31 are typically pivotally attached to an adjustment mechanism. The arms are typically formed from carbon steel and the sponson buoyancy is typically formed from glass reinforced plastic. All pivot points and bearing surfaces are typically faced with low friction polymers such as PTFE.

In the embodiment shown in the figures, the adjustment mechanism comprises an adjustment mechanism having a vertical traveller 40 and a rotational traveller 50.

The vertical traveller 40 (FIGS. 9-15) comprises an upper ring 45 and a lower ring 44, which are inter-connected by channel members 43. The upper and lower rings 45, 44 are parallel to one another, and are spaced apart by the channel members 43, which are orthogonal to the rings, so that when the rings are disposed in the vertical plane, the channel members 43 are disposed in the vertical plane. The channel members 43 have channels 41 that face radially inwardly with respect to the rings 44, 45, and the vertical traveller is mounted on one or more guide rails 25 which are received within respective channels 41. The guide rails 25 can slide within the channels 41, so that the vertical traveller 40 can move vertically with respect to the guide rails, but the interaction between the sides of the guide rails 25 and the sides of the channels 41 prevents relative rotational horizontal movement between the guide rails 25 and the vertical traveller 40.

The guide rails 25 are typically fixed to the column 3 of a wind turbine W, or to a sleeve 3s mounted on the outer surface of the column 3. In some embodiments, the guide rails can be welded or glued to the column or the sleeve, or alternatively they can be clamped thereto, using an annular clamp (not shown) or formed directly as part of the column or sleeve. Attachment of the guide rails 25 to the sleeve or the column can be carried out onshore or offshore. The guide rails 25 are arranged parallel to one another, and are parallel to the channels 41, so that the vertical traveller 40 can slide up and down relative to the fixed guide rails 25 restrained within the channels 41, on the outer surface of the column 3. Optionally the guide rails 25 can have an upwardly facing stop member (not shown) to limit the downward travel of the vertical traveller 40 on the guide rails 25.

Each guide rail 25 typically has a vertical movement actuator, such as a hydraulic cylinder 46 fixed thereto at an upper end, and having a piston that extends downwards toward the vertical traveller 40. The free end of each piston is typically connected to the upper ring of the vertical traveller 40, typically at a position radially outward from each of the channels 41, to secure the vertical traveller 40 to the guide rails. Extension of the pistons lowers the vertical traveller 40 on the rails 25, and retraction of the pistons raises it. The pistons are typically operated together so that the vertical traveller moves parallel to the column 3. It will be appreciated by the skilled person that the hydraulic pistons are one way of raising and lowering the vertical traveller and other embodiments could use other mechanisms, such as rack and pinion mechanisms, with hydraulic or electric motors etc.

The upper ring 45 has a brake in the form of a number of (e.g. four) circumferentially spaced C-shaped static brakes 47s illustrated in detail in FIGS. 12-15, with hydraulic cylinders 48 driving pistons downwards. The upper ring also has four slew cylinder mounting bosses 49, the function of which will be described below.

The vertical traveller 40 typically remains rotationally static with respect to the column 3, and moves in the vertical plane only. The rotational traveller 50 is typically mounted on the outside of the vertical traveller 40, and rotates around it, but does not move vertically with respect to it. The other main function of the rotational traveller in this embodiment is to act as a mounting for the wave follower arms 21 and 31.

The rotational traveller 50 has an upper ring 55 and a lower ring 54, interconnected by braces 53. The braces are typically non parallel to one another. The rings 54 and 55 are typically parallel. The upper ring 55 typically has a larger outer diameter than the inner ring, and has an optional walkway 55w, but both the upper ring 55 and lower ring 54 have inner diameters configured to receive and engage with the outer surface of the vertical traveller 40.

The lower ring 54 has two pairs of lower pivot mountings 54p, each pair being located on opposite sides of the rotational traveller 50, and each lower pivot mounting 54p in each pair being spaced equally apart on either side of a midline A of the rotational traveller 50. The upper ring 55 has two (or more) upper pivot mountings 55p, typically disposed on the midline A of the rotational traveller, at opposite sides. The upper and lower pivot mountings 55p, 54p provide three fixed positions on the rotational traveller 50 for pivotal connection of the inner ends of the arms 41, 51.

On the upper ring 55 of the rotational traveller 50, there is an inner rim 56 having a narrower diameter than the outer diameter of the upper ring 45 of the vertical traveller 40. Thus when the rotational traveller 50 is assembled onto the vertical traveller, the inner rim 56 extends radially inwardly over the upper surface of the upper ring 45 of the vertical traveller. The inner rim 56 forms a vertical bearing pad between the two as shown in FIG. 8, overlapping the upper ring 45 of the vertical traveller 40. Vertical loads on the rotational traveller 50 are transmitted through the inner rim 56 onto the upper ring 45 of the vertical traveller 40. A low friction polymer can be provided on each bearing surface. The inner rim 56 pad supports the rotational traveller 50 on the upper ring 45 of the vertical traveller 40, so that it moves up and down in the vertical plane along with the vertical traveller 40. The bearing pad between the two upper rings 45, 55 also allows the rotational traveller 50 to rotate freely relative to the rotationally static vertical traveller 40.

The inner rim 56 extends into the C-shaped clamps 47 on the vertical traveller 40, and extension of pistons on the cylinders 48 drives the piston heads down to clamp the inner rim 56 and prevent rotational movement.

One end of a slew cylinder 42 is typically pivotally connected to each mounting boss 49 on the vertical traveller 40, and the free end of each piston is typically pivotally connected to a respective dynamic brake 47d mounted on the inner rim 56 of the rotational traveller, thereby connecting the slew cylinder 42 between the vertical traveller 40 and the rotational traveller 50. With the dynamic brakes 47d applied to the inner rim 56, the pistons are extended to rotate the rotational traveller 50 relative to the vertical traveller. Once the travel limit of the pistons is reached, the static brakes 47s are applied to grip the rim 56 in that rotated position, the dynamic brakes are released, and the pistons retracted to repeat the operation. Once the rotational traveller has been rotated in this manner to the correct orientation with the sponsons 20, 30 parallel to the oncoming waves, the static brakes are applied, the dynamic brakes released, and the pistons retracted in order to limit the exposure of the piston rods to rain, debris and spray.

An alternative slew ring mechanism could comprise a large geared ring mounted on the rotational traveler 50, with motors mounted on the vertical traveler 40, and being fitted with pinion gears which engage with the large gear ring. By activating the motors the large geared ring will be driven rotating the rotational traveler 50.

In some embodiments the rotational movement can be passive, rather than active, or a combination of both.

Typically the rotational traveller can have a maximum slew angle of less than 360 degrees, and typically between 180 and 360 degrees or it could be unrestricted. The arms 21 and 31 are typically arranged along an axis, and so while it is preferred that the forward sponson 20 mounted on the slightly shorter forward arm 21 meets an oncoming wave before the aft sponson 30 mounted on the slightly longer aft arm, the apparatus will function equally well in reverse.

The arms 21, 31 and the sponsons 20, 30 are optionally assembled onshore, and are attached to the adjustment mechanism in the water, after the adjustment mechanism has been attached to the column.

The arms 21, 31 each have two lower struts 211, 311, and one upper strut 21u, 31u. The inner ends of the struts are aligned with the pivot points 54p and 55p on the rotational traveller; the inner ends of the lower struts 21l, 31l connect pivotally to the pivot points 54p on the lower ring 54, and the upper struts 21u, 31u connect pivotally to the upper pivot point 55p on the upper ring 55 via a fluid compressor in the form of a hydraulic cylinder 60. The pistons in the hydraulic cylinders 60 are extended and retracted by the pivotal movement of the arms relative to the rotational traveller 50, driven by the motion of the waves acting on the sponsons 20, 30. The pressurised fluid from the hydraulic cylinders 60 is used to drive electric motors functioning as generators 65 in order to generate electricity, which can be exported using the conventional power export facilities on the wind turbine W.

The incoming energy applied to the sponsons 20, 30 (and therefore the potential energy generated by the hydraulic cylinders) as a result of the vertical movement of the arms 21, 31 around their respective pivot points typically varies as a wave passes, increasing from zero just before the sponson 20, 30 rises up from the trough, dropping off to zero at the wave peak, and then building up again as the sponson 20, 30 drops down the back of the wave before returning to zero and then starting the process again. In addition waves are not consistent in height and shape and so the input energy flow, although not completely random, is constantly changing. In contrast it is desirable that the power output of electrical energy from the apparatus to the grid is as close as possible to a constant energy flow with variations in power fluctuation reduced to a minimum.

In order to achieve this smoothing effect, accumulators are typically used. Optionally, conventional hydraulic accumulators (not shown) can be placed between the hydraulic cylinders 60 and the hydraulic motors 65. When the incoming kinetic energy peaks and along with it the potential energy in the pressurized fluid, the excess potential energy is typically absorbed by the hydraulic accumulators. When the kinetic and potential energy drops the excess pressure is released by the accumulators, helping the motors to see a consistent pressure in the driving fluid.

Alternatively the cylinder outputs can be connected directly to the motors and power control electronics systems are optionally used on the electrical side to smooth the power output.

Optionally the generators 65 are mounted close to the hydraulic cylinders 60 thereby minimizing hose and pipe runs and maximizing efficient energy flow. The generator housings can optionally incorporate coolers and ventilation apertures such as louvers allowing air to circulate but keeping rain water and spray out.

In use, the guide rails 25 are attached to the sleeve 3s or the column 3 and the vertical traveller 40 (which can typically be split into two semi-circles for easy assembly) is mounted on the guide rails. The hydraulic cylinders are then connected between the guide rails 25 and the vertical traveller 40. The rotational traveller 50 is then separately mounted onto the vertical traveller 40. The height of the vertical traveller 40 is then adjusted so that the pivot points 54p are close to the waterline 2, and the arms 21, 31 to which the sponsons 20, 30 are attached, are connected to the pivot points 54p and to the hydraulic cylinders 60, which in turn are connected to the upper pivot points 55p. Once the arms 21, 31 are attached to the rotational traveller 50, with the sponsons 20, 30 floating and the arms 21, 31 generally horizontal as shown in FIG. 1, the rotational traveller 50 is rotated by the slew cylinders 46 until the sponsons 20, 30 are parallel to the oncoming waves, with the forward sponson 20 meeting each wave before the aft sponson 30. When the most efficient position is reached, the rotational traveller 50 is locked in place by the static clamps 47s and the potential energy in the pressurised fluid from the hydraulic cylinders 60 is converted into electrical energy by the generators 65. The generators and the adjustment mechanism can be serviced and optionally operated by accessing the apparatus by means of the optional walkway, although in some embodiments, the adjustment mechanism can be remotely controlled from a ship, or another wave energy generator apparatus, or from a land-based control centre.

The sponsons 20, 30 are typically attached to the distal ends of the arms 21, 31 by means of swivel joints 30s, which allow rotation of the sponsons 20, 30 around the central axis D of the lower struts of the arms in the range of rotation shown by the arrow C in FIGS. 25 and 26. This allows the sponsons 20, 30 to swivel around the axis of the swivel joints 30s, which is generally parallel to the water line 3 as shown in FIG. 27. Thus, waves hitting the sponsons 20, 20 from the side of the sponson 20 will cause it to roll with the wave, lifting one side of the sponson above the other, and reversing its rolling movement as the wave passes, thereby isolating the torque from the arm and reducing wear on the arm.

In some embodiments, the sponson 20, 30 can be pivotally connected to the arm around the long axis F of the sponson, allowing pivotal movement of the sponson 20, 30 in the range of rotation shown by the arrow E in FIGS. 25 and 26. This allows the sponsons 20, 30 to pivot around the axis of the sponson, which is generally parallel to the water line 3 as shown in FIG. 27 and is parallel to the axis D of the arm. Thus the float can lie across the wave face as it hits the float, hence absorbing more energy from the wave than would be possible if the float was rigidly attached and held in the same orientation with respect to the wave. Also, the pivoted float is more adaptable to absorb energy from different heights of wave than would be the case with a rigidly attached float.

In some embodiments the connection between the float and the arm can allow pivotal movement around more than one axis, optionally at the same time.

FIGS. 28 and 29 show a second embodiment of a wave energy generation apparatus 110. The second embodiment 110 is connected to a leg 3 of a wind turbine, and incorporates generally similar features to the previous embodiment, and similar features are indicated in the second embodiment with the same reference number, added to 100. Similar features will therefore not be described again in detail here. The wave energy generation apparatus 110 has an arm extending generally parallel to the x axis and a wave follower extending generally parallel to the z axis (see FIG. 28) with an adjustment mechanism connected around the leg 3 in general alignment with the y axis. The apparatus 110 comprises at least one (possibly more than one) wave follower in the form of a float and specifically in this example, in the form of a sponson 120 pivotally attached to the outer end of a lever arm 121, which itself is pivotally attached to an adjustment mechanism as described for previous embodiments.

The vertical traveller 140 and rotational traveller 150 of the adjustment mechanism are substantially similar to the previous embodiment and can have a vertical movement actuator, such as a hydraulic cylinder 146 fixed thereto at an upper end.

In the second embodiment, at least one geared slew drive can be used in place of the hydraulic cylinder for driving relative rotation of the rotational traveller. FIG. 32 shows the vertical traveller 140 that operates in a similar manner to the vertical traveller 40, but has a number of geared slew drives 142 instead of hydraulic cylinders 42 to drive the rotation of the rotational traveller around it. The geared slew drives 142 are mounted on the vertical traveller 140 and engage with the inner face of an annular gear 147 that is mounted on the rotational traveller 150. The slew drives 142 are driven in rotation (typically together) to move the rotational traveller around the axis of the vertical traveller 140. The use of slew drives is advantageous as it can in some cases reduce the need for braking or locking systems, as the slew drives 142 can be used to prevent further rotational movement of the two components.

The arm 121 is connected to the rotational traveller 150 by lower pivot mountings 154p and upper pivot mountings 155p. The upper and lower pivot mountings 155p, 154p provide fixed positions on the rotational traveller 150 for pivotal connection of the inner end of the arm 121. The arm 121 is formed of a lower strut 121l and an upper strut 121u. At the inner end the lower strut 121l connects to the lower pivot mounting 154p and the upper strut 121u connects to the upper pivot mounting 155p, through a bank of four (or more or less) hydraulic cylinders 160. The upper and lower struts 121u and 121l are rigidly connected together at the outer ends at 122. The outer end of the arm 121 also connects to the sponson 120, at pivot axis 123. The pivot axis 123 extends generally parallel to the z axis and to the waterline, and is generally perpendicular to the axis of vertical movement of the vertical traveller 140 (see FIG. 28). The sponson 120 is adapted to pivot around the pivot axis 123 in response to the pitch of a wave as it passes (see FIGS. 33-36), typically within a restricted range shown schematically by arrow G in FIG. 29. The pitching movement of the sponson 120 around the pivot axis 123 energises a fluid compressor in the typical form of hydraulic cylinder 170, which is connected between the sponson 120 and the upper strut 121u at pivot point 171. A multiple of pitch-energised hydraulic cylinders can be provided here, as previously described. Therefore, pitching movement of the sponson 120 in response to passage of waves compresses fluid through the pitch energised cylinders 170 separately of the vertical heave energised action of the cylinders 160. Accordingly, the energy extracted from the passage of the wave is converted from vertical heaving motion of the sponson by the cylinders 160, and from pitching motion of the sponson by the cylinders 170, thereby extracting more of the wave's energy than the action of a single heave or pitch related movement alone.

The cylinders 170 can energise the accumulators in the same way as cylinders 160, and 60, or can be connected directly to the motors and power control electronics systems as previously described.

FIGS. 30 and 31 show a further embodiment of a wave energy generation apparatus 210. The second embodiment 210 is connected to a leg 3 of a wind turbine, and incorporates generally similar features to the second embodiment, and similar features are indicated in the second embodiment with the same reference number, added to 100. Similar features will therefore not be described again in detail here. The wave energy generation apparatus 210 has an arm extending generally parallel to the x axis and a wave follower extending generally parallel to the z axis (see FIG. 28) with an adjustment mechanism connected around the leg 3 in general alignment with the y axis. The apparatus 210 comprises at least one (possibly more than one) wave follower and in this example, comprises a sponson 220 pivotally attached to the outer end of a lever arm 221, which itself is pivotally attached to an adjustment mechanism as described for previous embodiments.

The vertical traveller 240 and rotational traveller 250 of the adjustment mechanism are substantially similar to the previous embodiment and can have a vertical movement actuator, such as a hydraulic cylinder 246 fixed thereto at an upper end.

The arm 221 is connected at its inner end in the same way as described for the previous embodiment. The arm 221 is formed of a lower strut 221l and an upper strut 221u. The upper and lower struts 221u and 221l are connected together at the outer ends 222, but in the case of the present embodiment, the lower strut 221l is generally parallel to the waterline and the pivot axis 223 around which the sponson 220 moves is above the waterline. The pivot axis 223 also extends generally parallel to the z axis and to the waterline, and is generally perpendicular to the axis of vertical movement of the vertical traveller 240. Thus moving parts and pivot bearings etc in the present example are largely held above the waterline. The arm 221 can optionally be rigid in this example. The floating sponson 220 is adapted to pivot around the pivot axis 223 in response to the pitch of a wave as it passes, optionally within a restricted range shown schematically by arrow H in FIG. 30. The pitching movement of the sponson 220 (shown in sequence in FIGS. 37-40) around the pivot axis 223 energises a fluid compressor in the typical form of a bank of hydraulic cylinders 270, which are connected via rod 272 between pivot points 271 and 273 on the sponson 220 and the upper strut 221u. A different multiple of pitch-energised hydraulic cylinders can be provided here, or a single cylinder, as previously described. Therefore, pitching movement of the sponson 220 in response to passage of waves compresses fluid through the pitch energised cylinders 270 separately of the vertical heave energised action of the cylinders 160. Accordingly, the energy extracted from the passage of the wave is converted from vertical heaving motion of the sponson by the cylinders 160, and from pitching motion of the sponson by the cylinders 270, thereby extracting more of the wave's energy than the action of a single heave or pitch related movement alone.

One advantage of the FIG. 30 embodiment is that the moving parts of the apparatus can be kept above the waterline, allowing easy maintenance and longer service life. Also, the arm 221 can be arranged in a more horizontal attitude so that it can support a walkway more easily, allowing safe and easy access to the apparatus and to the wind turbine by service personnel from a vessel.

The cylinders 270 can energise the accumulators in the same way as cylinders 160, and 60, or can be connected directly to the motors and power control electronics systems as previously described.

Modifications and/or improvements may be made to the embodiments hereinbefore described without departing from the scope of the invention.

1. Apparatus for generating electric energy from wave motion, comprising:
at least one wave follower configured to be moved by wave motion; and
an energy converter configured to convert kinetic energy from the movement of the wave followers into electric energy;
wherein the at least one wave follower is configured to connect to a fixed structure, and wherein the apparatus has an adjustment mechanism configured to move the wave follower rotationally and/or vertically relative to the fixed structure.

2. Apparatus as claimed in claim 1, wherein the adjustment mechanism is configured to move rotationally in a substantially horizontal plane that is substantially parallel with the surface of the fluid through which the waves are moving.

3. Apparatus as claimed in claim 2, wherein the adjustment mechanism is configured to move orthogonally with respect to the plane of rotational movement of the adjustment mechanism.

4. Apparatus as claimed in claim 1, wherein the adjustment mechanism is connected to the fixed structure, and is movable rotationally around the axis of the fixed structure and/or vertically along the axis of the fixed structure, and wherein the wave follower is pivotally connected to the adjustment mechanism at a pivot point, and wherein the pivot point is movable with the adjustment mechanism rotationally and/or vertically with respect to the fixed structure.

5. Apparatus as claimed in claim 1, wherein the adjustment mechanism comprises a vertical traveller and a rotational traveller.

6. Apparatus as claimed in claim 1, wherein the wave follower comprises a float and an arm connecting to the float, and incorporating a pivot joint on the wave follower between the float and the arm.

7. Apparatus as claimed in claim 6, wherein the float has an axis and wherein the axis of the pivot joint is parallel to the plane of rotational movement of the wave follower, and parallel to the axis of the float, whereby in use, the float is adapted to pivot around a horizontal axis and to pitch in the vertical plane.

8. Apparatus as claimed in claim 7, wherein the float is connected to the energy converter, which is adapted to collect and convert the kinetic energy from the pitching movement of the float.

9. Apparatus as claimed in claim 6, wherein the float has an axis and wherein the axis of the pivot joint is parallel to the plane of rotational movement of the wave follower, and perpendicular to the axis of the float, whereby in use, the float is adapted to pivot around a horizontal axis and to roll laterally when waves hit a side of the float.

10. Apparatus as claimed in claim 6, wherein the float is mounted beneath the arm.

11. Apparatus as claimed in claim 1, wherein the float is connected to the energy converter, which is adapted to collect and convert the kinetic energy from the movement of the float in the vertical plane.

12. Apparatus as claimed in claim 1, wherein at least two wave followers are provided on the fixed structure, and wherein the arrangement of the wave followers on the fixed structure is asymmetric.

13. Apparatus as claimed in claim 1, wherein the apparatus includes a wave direction sensor.

14. Apparatus as claimed in claim 13, wherein the wave direction sensor provides a signal to a controller, and wherein the controller is adapted to provide a signal to initiate rotational movement of the adjustment mechanism in response to the signal from the wave direction sensor.

15. Apparatus as claimed in claim 1, wherein the wave follower is moved rotationally in the horizontal plane, across the water line by a rotation mechanism.

16. Apparatus as claimed in claim 14, wherein the wave follower is moved rationally in the horizontal plane, across the water line by a rotation mechanism, and further wherein the rotation mechanism is linked to and can move in response to the wave directional sensors.

17. Apparatus as claimed in claim 1, wherein the apparatus includes an energy accumulator, and wherein the energy converter converts the kinetic energy from movement of the or each wave follower into potential energy which is stored in the energy accumulator before the energy converter converts the stored potential energy into electrical energy.

18. Apparatus as claimed in claim 1, wherein the fixed structure comprises a leg or jacket of a wind turbine.

19. Apparatus as claimed in claim 1 having a height sensor that senses the height of certain components of the apparatus above the water in which the apparatus is being used.

20. Apparatus as claimed in claim 19, wherein the height sensor is adapted to relay a signal to a controller which is adapted to initiate vertical movement of the adjustment mechanism to adjust the vertical height of the apparatus above the water line in order to compensate for changes in the water line height.

21. Apparatus as claimed in claim 1, wherein the energy converter comprises at least one electrical generator that is driven by hydraulic fluid pressurized by a fluid compressor connected between the wave follower and the adjustment mechanism and activated to pressurize fluid as a result of the movement of the wave follower.

22. Apparatus as claimed in claim 21, wherein multiple generators are connected to the fluid compressor.

23. A method for energy generation from wave motion comprising:
providing at least one wave follower configured to move in response to wave motion; converting kinetic energy of the wave follower into electrical energy;
wherein the at least one wave follower is configured to connect to a fixed structure; and is configured to move rotationally and/or vertically relative to the fixed structure.
